(19) United States
(12) Patent Application Publication
(10) Pub. No.: US 2005/0195547 A1
(43) Pub. Date: Sep. 8, 2005

(54) Structure of safety power adapter

(76) Inventor: Shang-Lung Huang, Tai Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/038,221

(22) Filed: Jan. 21, 2005

(30) Foreign Application Priority Data
Mar. 5, 2004 (TW) 93203330

(51) Int. Cl. H02H 5/04

(52) U.S. Cl. 361/103

(57) ABSTRACT

A safety power adapter has a base, two terminal blade receiving elements, two conducting elements, and two low-melting-point alloy pieces with current-limit and heat-conduction functions. Two chambers are disposed on the base. One terminal blade receiving element is for embedding of a terminal blade of an external plug and one conducting element is for inserting into an insertion hole of an external power socket are disposed in each chamber. Each low-melting-point alloy piece is connected between one terminal blade receiving element and one conducting element. The alloy piece can break and protect against a overcurrent by means of the specific current density together with predetermined cross section thereof. The alloy piece can also break and protect from overheating by means of the low-melting-point feature when heat accumulates due to incomplete power contact, hence protecting the safety power adapter and the external power socket on the source side.

### BACKGROUND OF THE INVENTION

1. Field of the Invention

The present invention relates to a structure of a safety power adapter and, more particularly, to a structure of a safety power adapter with overheating and overcurrent protection.

2. Description of Related Art

According to the literature, many residential fires are related to the overheating of insulating resin in conventional power sockets. For example, with frequent insertion and removal of plugs from power sockets, terminal receiving blade elements of the sockets lose elasticity gradually and suffer elasticity fatigue. Elasticity fatigue always leads to incomplete contact between plugs and terminal receiving blade elements. Afterwards, incomplete contact generates overcurrent as well as over-heating. Insulating resin deteriorates after being over-heated over a long period of time. Finally, short circuits and sparks will follow, and lead to fire. Unfortunately, the overheating of insulating resin seldom triggers self-protection mechanism of household circuits, such as fuseless breakers. Technically, incomplete power contact will take place either when the contact element's (the contact elements including conducting pins of external plugs and terminal receiving blade elements) surface is oxidized, rusted or collects dust, or when the elasticity of the contact elements decreases.

Fuses or detection circuits are frequently utilized for overcurrent control in conventional power sockets; however, just like the prevalent fuseless breakers installed in a household circuit, they cannot provide direct protection against the overheating of insulating resin in power sockets or against the resulting overcurrent.

### SUMMARY OF THE INVENTION

An object of the present invention is to provide a structure of safety power adapter with overheating and overcurrent protection.

To achieve the above object, the present invention proposes a safety power adapter comprising a base having two or more chambers, two or more terminal blade receiving elements for plug insertion, two or more conducting elements, and two or more low-melting-point alloy pieces with heat-conduction and current-limiting functions. The terminal blade receiving elements are disposed in the chambers of the base.

The conducting elements are also disposed in the chambers of the base with their lower portions exposed out of the base. The low-melting-point alloy pieces are joined between the terminal blade receiving elements and the power conducting elements, and break when overheated due to incomplete power contact.

A groove is formed in either side of each of the chambers. A through hole is formed in the bottom face of each of the chambers.

The above terminal blade receiving element is composed of a curved resilient arm and a sheet-shaped resilient leaf portion. A receiving space is formed between the resilient arm and the resilient leaf portion.

The conducting element is a conducting copper element. A protuberance is formed at either side of the upper part of the conducting copper element to be embedded in the groove of the base.

The alloy piece has a low melting point, and is sheet-shaped. The alloy piece can be soldered between the terminal blade receiving element and the conducting element and can also be welded between the terminal blade receiving element and the conducting element.

A cover body is connected on the base. Two or more socket holes are formed on the cover body. The alloy piece can break and protect against a overcurrent by means of the specific current density together with predetermined cross section thereof. The alloy piece can also break and protect from overheating by means of the low-melting-point feature when heat accumulates due to incomplete power contact. In addition, the alloy piece breaks when overheated due to a short circuit caused by insulation failure of resin. The power adapter and the external power socket on the source side can thus be protected. Hence, the present invention can protect power sockets from overcurrent and overheating, and increase household safety.

In addition, the low-melting-point alloy generally breaks around the temperature of 67° C. Insulating resin can be perfectly intact per se even when the alloy breaks, because insulating resin can endure temperatures in excess of 90° C.

### BRIEF DESCRIPTION OF THE DRAWINGS

The various objects and advantages of the present invention will be more readily understood from the following detailed description when read in conjunction with the appended drawing, in which:

FIG. 1 is an exploded perspective view of the present invention;

FIG. 2 is a cross-sectional view of the present invention after assembly;

FIG. 3 is a perspective assembly view of a terminal blade receiving element, a conducting element, and an alloy piece of the present invention;

FIG. 4 is an exploded perspective view of FIG. 3;

FIG. 5 is a side view of FIG. 3;

FIG. 6 is a perspective assembly view of a terminal blade receiving element, a conducting element, and an alloy piece according to a second embodiment of the present invention;

FIG. 7 is a side view of FIG. 6;

FIG. 8 is a perspective assembly view of a terminal blade receiving element, a conducting element, and an alloy piece according to a third embodiment of the present invention; and

FIG. 9 is a side view of FIG. 8.

### DETAILED DESCRIPTION OF THE PREFERRED EMBODIMENTS

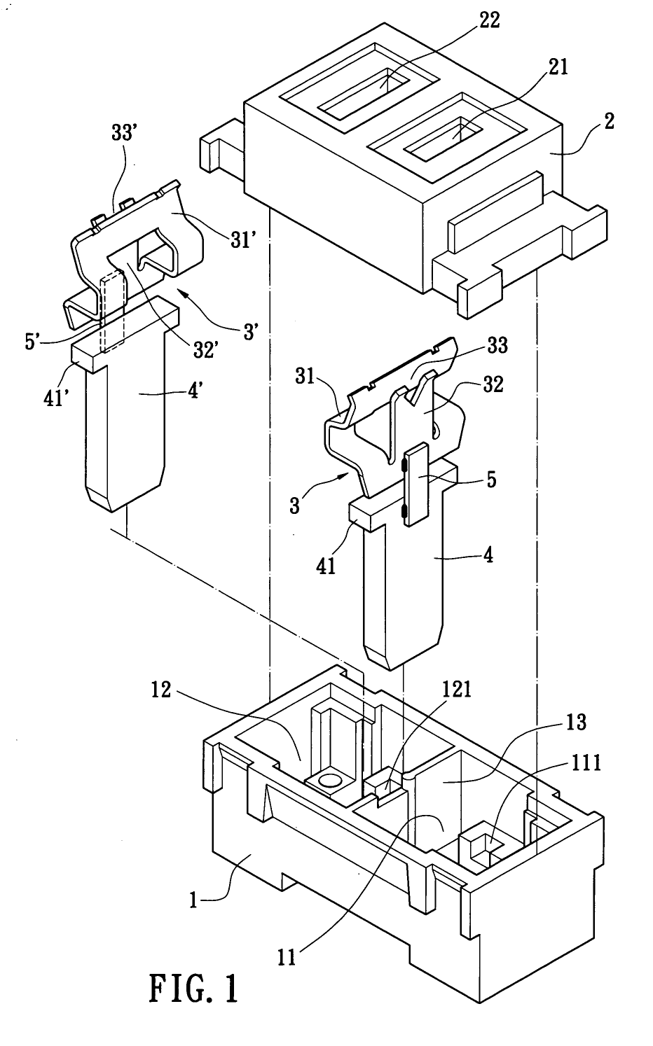

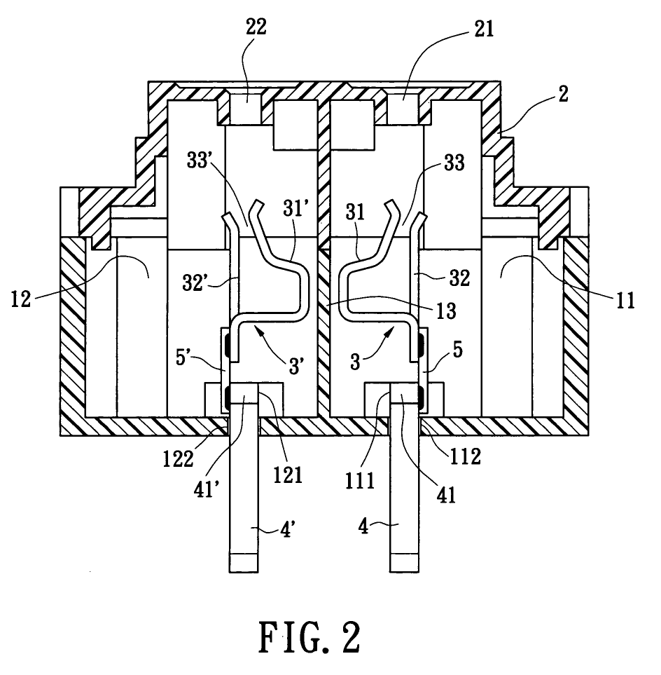

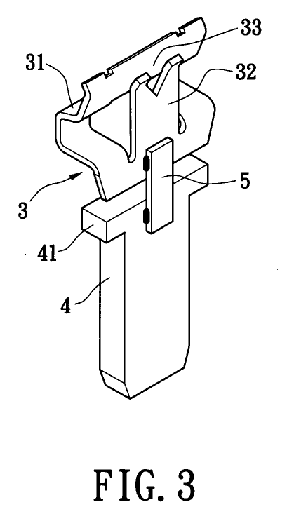

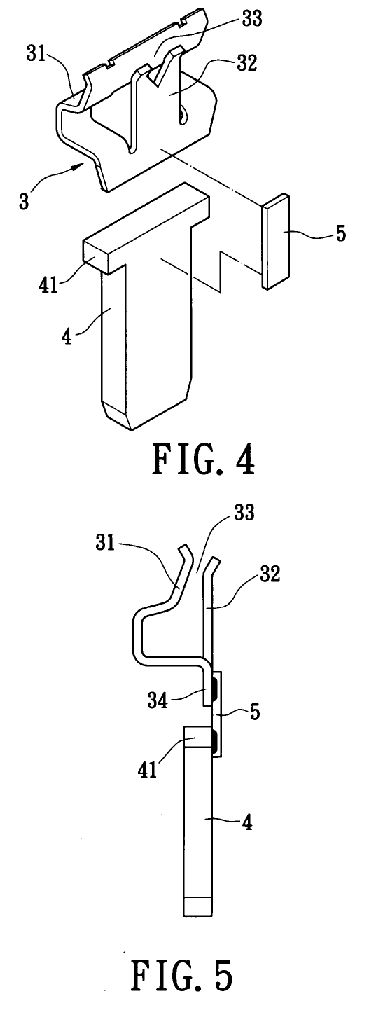

As shown in FIGS. 1 to 5, the present invention proposes a structure of safety power adapter. The present invention provides a cost-effective and feasible solution to the overheating of power sockets due to incomplete power contact or insulation failure of resin. The present invention can apply to two-hole or multi-hole power sockets. The present invention is primarily exemplified with two-hole power sockets. The safety power adapter comprises a base 1, a cover body 2, two terminal blade receiving elements 3 and 3′, two conducting elements 4 and 4′, and two alloy pieces 5 and 5′ with current-limit and heat-conduction functions.

The base 1 has two chambers 11 and 12. A shield piece 13 is disposed between the two chambers 11 and 12. A groove 111 (121) is formed at either side of the chamber 11 (12). A through hole 112 (122) is formed at the bottom face of the chamber 11 (12).

The cover body 2 is joined on the base 1, and has two socket holes 21 and 22 for guiding insertion of conducting pins (not shown) of an external plug.

The two terminal blade receiving elements 3 and 3′ are disposed in the chambers 11 and 12, respectively. Each terminal blade receiving element 3 (3′) is composed of a curved resilient arm 31 (31′) and a sheet-shaped resilient leaf portion 32 (32′). A receiving space 33 (33′) is formed between the resilient arm 31 (31′) and the resilient leaf portion 32 (32′).

Each conducting element 4 (4′) is a T-shaped conducting copper sheet with the lower end embedded in the through hole 112 (122) and exposed out of the base 1. A protuberance 41 (41′) extends outwards from either side of the upper part of each conducting element 4 (4′) to be embedded in the groove 111 (121) of the base 1.

The two alloy pieces 5 and 5′ are soldered between the lower parts of the two terminal blade receiving elements 3 and 3′ and the upper parts of the two conducting elements 4 and 4′, respectively. Each alloy piece 5 (5′) is a low-melting alloy piece such as a Wood alloy piece. The Wood alloy piece immediately breaks when heated over the temperature of 67° C. Further, the alloy piece 5 (5′) can break and protect against overcurrent by means of the specific current density together with predetermined cross section thereof. The alloy piece 5 (5′) can also break and protect against overheating by means of the low-melting-point feature when heat accumulates due to incomplete power contact. The incomplete power contact will take place either when the contact element's (either sockets or plugs) surface is oxidized, rusted or collects dust, or when the elasticity of the terminal blade receiving element 3 (3′) decreases. With the above characteristics of the alloy piece 5 (5′), the alloy piece 5 (5′) will also break when overheated due to a short circuit caused by insulation failure of resin. Therefore, the object of protecting the power adapter and the external power socket on the source side can be accomplished.

The lower end of the conducting element 4 (4′) of the safety power adapter is embedded in an insertion hole of an external power socket while in use. After a period of use, the elasticity of the conducting elements 4 (4′) of the power adapter or the external power socket decreases. This leads to incomplete power contact, and even a short circuit for the worse. The alloy piece 5 (5′) breaks when overheated or in the case of overcurrent, thereby protecting the power adapter and the external power socket on the source side.

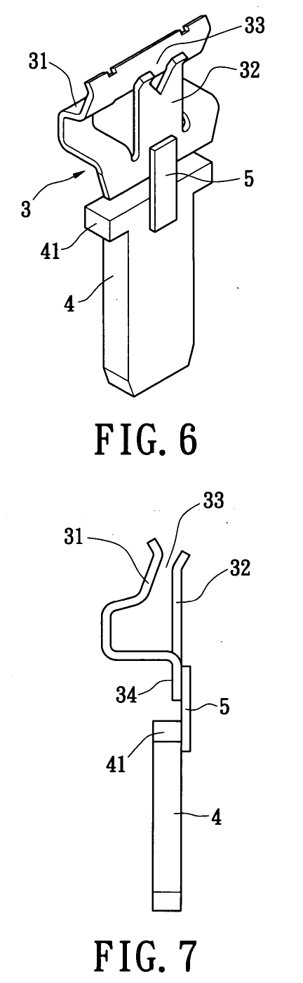

As shown in FIGS. 6 and 7, the alloy piece 5 (5′) of the present invention can also be welded together with the terminal blade receiving element 3 (3′) and the conducting element 4 (4′).

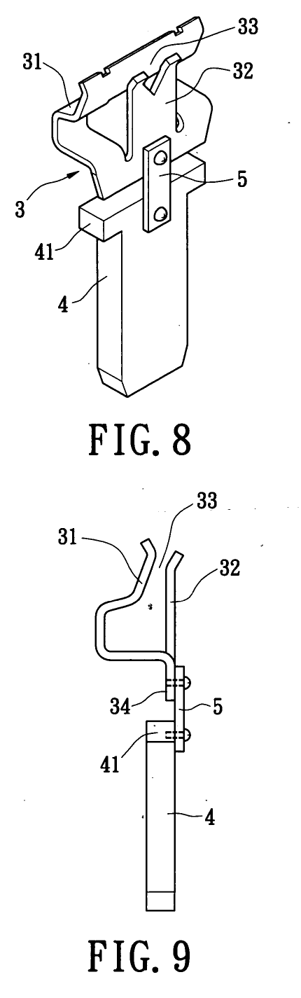

As shown in FIGS. 8 and 9, the alloy piece 5 (5′) of the present invention can also be screwed together with the terminal blade receiving element 3 (3′) and the conducting element 4 (4′).

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A structure of a safety power adapter applied to an external power socket, said safety power adapter comprising:
a base having two or more chambers;
two or more terminal blade receiving elements for embedding of conducting pins of an external plug, said terminal blade receiving elements being disposed in said chambers of said base;
two or more conducting elements also disposed in said chambers of said base, with lower parts of said conducting elements exposed out of said base; and
two or more low-melting-point alloy pieces connected between said terminal blade receiving elements and said conducting elements;
whereby said low-melting-point alloy pieces break during a overcurrent or when overheated due to incomplete power contact, caused by surface oxidation, dust, or decreased elasticity.

2. The safety power adapter as claimed in claim 1, wherein a groove is formed in either side of each of said chambers, and a through hole is formed in a bottom face of each of said chambers.

3. The safety power adapter as claimed in claim 1, wherein each of said terminal blade receiving elements is composed of a curved resilient arm and a sheet-shaped resilient leaf portion, and a receiving space is formed between said resilient arm and said resilient leaf portion.

4. The safety power adapter as claimed in claim 1, wherein each of said conducting elements is a conducting copper sheet, and a protuberance is formed at either side of an upper part of said conducting copper sheet to be embedded in said groove of said base.

5. The safety power adapter as claimed in claim 4, wherein each of said conducting elements is a T-shaped conducting copper sheet.

6. The safety power adapter as claimed in claim 1, wherein said alloy piece has a low melting point.

7. The safety power adapter as claimed in claim 1, wherein said alloy piece is a Wood alloy piece.

8. The safety power adapter as claimed in claim 1, wherein said alloy piece is sheet-shaped.

9. The safety power adapter as claimed in claim 1, wherein said alloy piece is welded between said terminal blade receiving element and said conducting element.

10. The safety power adapter as claimed in claim 1, wherein said alloy piece is screwed between said terminal blade receiving element and said conducting element.

11. The safety power adapter as claimed in claim 1, wherein a cover body is connected on said base, and two or more socket holes are formed in said cover body.
